(19) United States
(12) Patent Application Publication
(10) Pub. No.: US 2026/0268678 A1
(43) Pub. Date: Sep. 10, 2026

(54) SYSTEM FOR MONITORING GLOBAL ENVIRONMENT

(71) Applicant: SoftBank Group Corp., Tokyo (JP)

(72) Inventor: Taiga TOMIOKA, Tokyo (JP)

(21) Appl. No.: 19/558,444

(22) Filed: Mar. 6, 2026

Related U.S. Application Data
(60) Provisional application No. 63/769,195, filed on Mar. 10, 2025.

(51) Int. Cl. G06V 20/52; G01S 13/90; G06V 10/82

(52) U.S. Cl. CPC G06V 20/52; G01S 13/90; G06V 10/82

(57) ABSTRACT

A system that combines generative AI and earth observation data to grasp phenomena occurring on the earth in real time and to provide information quickly and accurately. A data collection unit acquires data such as weather information and changes in topography from satellites, and a generative AI unit analyzes this to detect forest fires, typhoon paths, and the like. An information integration unit integrates the analysis results and provides comprehensive information to a user. A user interface unit visually displays related information through a terminal when a user inputs a search word.

### CROSS-REFERENCE TO RELATED APPLICATIONS

This application is based upon and claims the benefit of priority from U.S. Provisional Patent Application No. 63/769,195, filed on Mar. 10, 2025, the entire contents of which are incorporated herein by reference.

### BACKGROUND

Japanese Unexamined Patent Application Publication No. 2022-180282 discloses a method, which is a persona chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to grasp various phenomena occurring on the earth in real time and to provide information quickly and accurately. Conventionally, earth observation data has been enormous and complex, and because its analysis required specialized knowledge and time, it was difficult for general users to easily access and understand it. In addition, it was also difficult to integrate information from different data sources, and a great deal of effort was required to grasp the overall picture. Information that users demand may be quickly provided by efficiently analyzing earth observation data using generative AI and integrating different data. This makes it possible to support rapid decision-making in various fields, such as early warning of disasters, support for environmental protection activities, and furthermore, monitoring of global climate change.

Disclosed herein is a system including a data collection unit that acquires earth observation data, a generative AI unit that analyzes the acquired earth observation data, and an information provision unit that integrates the analyzed data and provides it to a user. The data collection unit acquires high-resolution earth observation data from a plurality of satellites orbiting the earth using optical sensors or radar. The generative AI unit preprocesses the acquired data and analyzes the data using deep learning technology. For example, it analyzes image data using a convolutional neural network and analyzes time-series data using a recurrent neural network. This detects the occurrence location and scale of forest fires, typhoon path predictions, ocean temperature changes, and the like. The information provision unit integrates the analyzed data and provides related information in real time by a user inputting a search word. This makes it possible for a user to quickly and accurately grasp phenomena occurring on the earth.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example method of providing earth observation data to a user.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be only A, may be only B, or may be a combination of A and B. Also, in the present specification, when three or more matters are expressed by being connected with “and/or”, the same concept as “A and/or B” is applied.

### First Embodiment

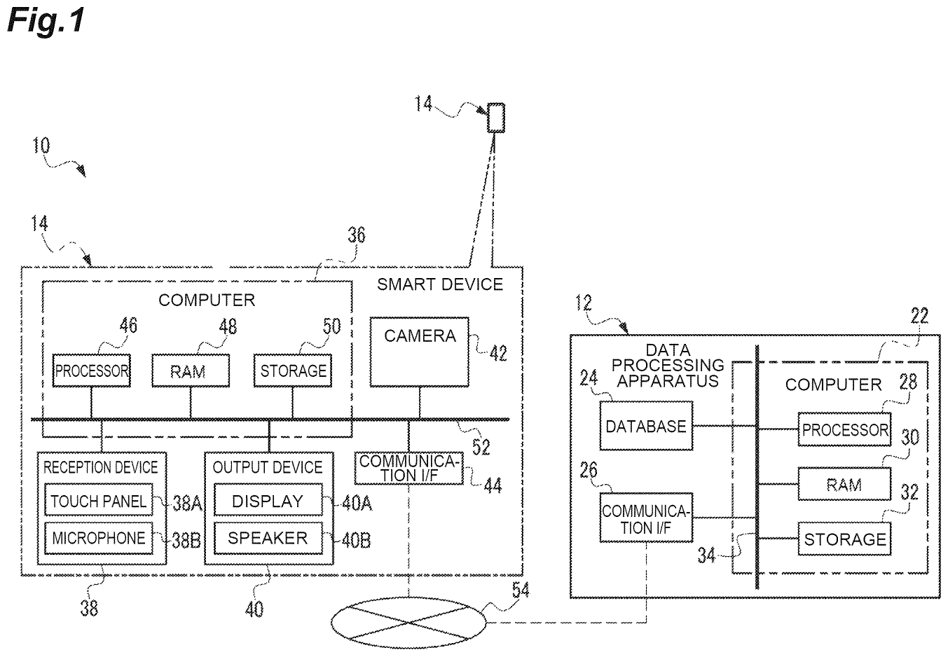

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a form perceivable by the user 20 (for example, voice and/or text). The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

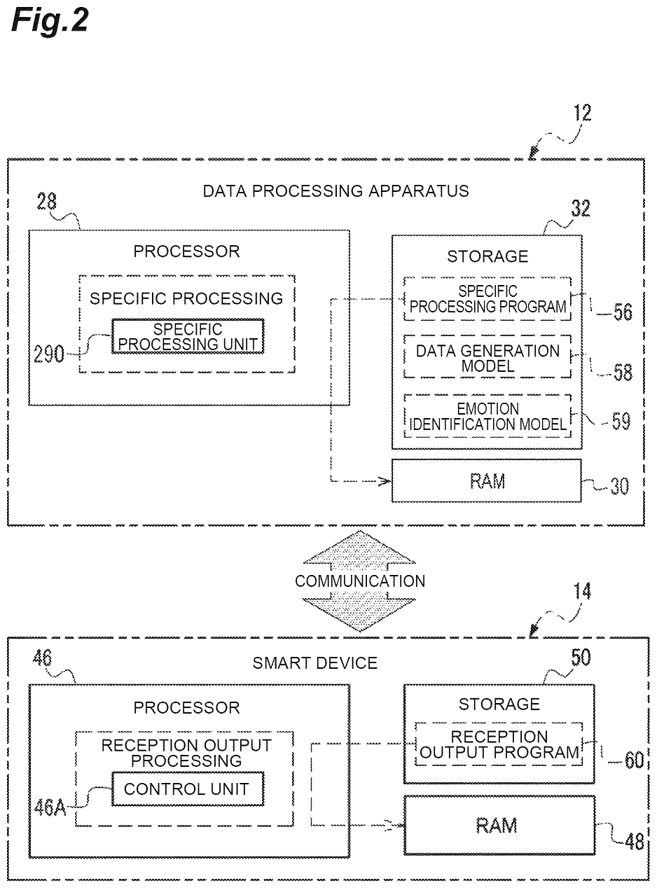

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 may have a data generation model and an emotion identification model similar to the data generation model 58 and the emotion identification model 59, and can also perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

### EXAMPLE 1.1

A flow of specific processing in Example 1 will be described. Each unit of the system described below is realized by the data processing apparatus 12 and the smart device 14. Also, the data processing apparatus 12 is referred to as a “server”, and the smart device 14 is referred to as a “terminal”.

A system configuration using a server and a terminal will be described more specifically and in detail.

First, collection of earth observation data is performed on the server side. The server is equipped with an advanced communication module for receiving data from a plurality of satellites orbiting the earth. This communication module receives high-resolution earth observation data acquired using optical sensors or synthetic aperture radar (SAR). For example, weather data such as cloud movement, temperature, humidity, and precipitation are acquired in real time from weather satellites. From environmental satellites, the health status of forests, vegetation indices, changes in ocean color, glacier movements, and the like are observed. These data are accumulated in a large-capacity database within the server and managed in time series.

Next, data analysis by generative AI is also executed on the server side. The server is equipped with high-performance processors such as GPUs and TPUs, and analyzes enormous amounts of data at high speed using deep learning technology. For example, it analyzes satellite image data using a convolutional neural network (CNN) and analyzes time-series data using a recurrent neural network (RNN) or a long short-term memory (LSTM) network. This makes it possible, for example, to detect the occurrence location and scale of forest fires with high accuracy, or to predict the path of a typhoon from several hours to several days ahead. Also, by analyzing changes in ocean temperature, it is also possible to detect signs of El Niño and La Niña phenomena at an early stage.

The analyzed data is further integrated within the server. By associating different types of data, comprehensive and multifaceted information is generated. For example, it evaluates the risk of flooding by combining weather data and topographical data, and constructs a damage prediction model. Also, by integrating ocean data and weather data, it is possible to monitor changes in marine ecosystems and use it for the management of fishery resources. Data mining technology and big data analysis technology are used for this integration process, and the accuracy and reliability of the information are improved.

An interface for a user to acquire information is realized on the terminal side. The terminal is provided with a touch screen or a voice recognition device for the user to input a search word. When the user inputs a specific search word, that information is transmitted from the terminal to the server via encrypted communication. The server extracts related data based on the received search word and transmits the analysis result to the terminal.

The terminal visually provides the received information to the user. For example, it indicates the occurrence location of a forest fire on a map and displays the damage range in different colors. It displays the path of a typhoon as an animation and indicates the predicted affected area. Also, as a text-format report, it is also possible to explain the analysis result in detail and visualize it using graphs and charts so that the user can easily understand it. Furthermore, the user can save the information or share it with other users.

In this way, the system may efficiently analyze earth observation data and provide information to a user in real time through the cooperation of a server and a terminal. This makes it possible to support rapid decision-making in various fields, such as early warning of disasters, support for environmental protection activities, and furthermore, monitoring of global climate change.

### System Configuration

The system includes a data collection unit, a generative AI unit, an information integration unit, and a user interface unit. The data collection unit is provided with an advanced communication module for receiving earth observation data from a plurality of satellites orbiting the earth. This communication module receives high-resolution data acquired using optical sensors or synthetic aperture radar. For example, weather data such as cloud movement, temperature, humidity, and precipitation are acquired in real time from weather satellites. From environmental satellites, the health status of forests, vegetation indices, changes in ocean color, glacier movements, and the like are observed. These data are accumulated in a large-capacity database within the server and managed in time series.

The data collection unit may be configured by, for example, the computer 22 (the processor 28 and the like) and the communication I/F 26 of the data processing apparatus 12, or may be configured by the specific processing unit 290, the specific processing program 56, and the like.

The generative AI unit uses a high-performance processor mounted on the server to analyze enormous amounts of data at high speed by making full use of deep learning technology. For example, it analyzes satellite image data using a convolutional neural network and analyzes time-series data using a recurrent neural network or a long short-term memory network. This makes it possible, for example, to detect the occurrence location and scale of forest fires with high accuracy, or to predict the path of a typhoon from several hours to several days ahead. Also, by analyzing changes in ocean temperature, it is also possible to detect signs of El Niño and La Niña phenomena at an early stage. Specific examples of prompt sentences to be read into the generative AI include “Analyze the latest satellite images and identify the location of the forest fire” and “Predict the path of the typhoon based on the weather data of the past 24 hours”.

The generative AI unit may be configured by, for example, the computer 22 (the processor 28 and the like) of the data processing apparatus 12, or may be configured by the specific processing unit 290, the specific processing program 56, the data generation model 58, and the like.

The generative AI unit includes a convolutional neural network (CNN) including a preprocessing layer for removing noise (clouds, atmospheric scattering, etc.) included in satellite image data, an encoder layer that performs feature extraction, and a decoder layer that performs event identification. In particular, in the detection of forest fires, a U-Net architecture is adopted, and by concatenating RGB image data and infrared thermal data in a channel direction and inputting the data, semantic segmentation for identifying smoke and clouds is executed. Thereby, a fire source at an initial stage, which is difficult to distinguish by human visual inspection, is identified with pixel-level accuracy.

In the analysis of time-series data, the generative AI unit uses a Transformer-based model (for example, a Vision Transformer or a Temporal Fusion Transformer). The model learns long-term dependencies by applying a Self-Attention Mechanism to a time-series sequence of past weather data (wind direction, wind speed, humidity), and improves prediction accuracy of a sudden course change (turning point) in typhoon path prediction. This produces a technical effect of resolving a gradient vanishing problem inherent in conventional RNNs and LSTMs and increasing parallel processing efficiency of computing resources.

The information integration unit further integrates the data analyzed by the generative AI unit and generates comprehensive and multifaceted information by associating different types of data. For example, it evaluates the risk of flooding by combining weather data and topographical data, and constructs a damage prediction model. Also, by integrating ocean data and weather data, it is possible to monitor changes in marine ecosystems and use it for the management of fishery resources. Data mining technology and big data analysis technology are used for this integration process, and the accuracy and reliability of the information are improved.

The information integration unit may be configured by, for example, the computer 22 (the processor 28 and the like) of the data processing apparatus 12, or may be configured by the specific processing unit 290, the specific processing program 56, the data generation model 58, and the like.

When integrating data from different data sources (optical satellites, SAR satellites, ground sensors), the information integration unit executes a sensor fusion algorithm using a Kalman filter or a particle filter. For example, when an optical sensor cannot observe the ground surface due to clouds, data of a synthetic aperture radar (SAR) that penetrates clouds is weighted and supplemented. At this time, the generative AI unit supplements missing data using a GAN (Generative Adversarial Networks) that generates an image equivalent to an optical image from a SAR image, thereby enabling continuous monitoring of a disaster situation.

The information integration unit has a feedback loop that dynamically controls an observation mode of the data collection unit (satellite or ground sensor) based on an analysis result. For example, for an area determined to have a high fire risk, a command signal is transmitted to increase an observation frequency of the satellite or increase a resolution of a ground camera. By this dynamic control, compared to a case where high-resolution data is constantly transmitted, consumption of communication bandwidth is significantly reduced while maintaining necessary monitoring accuracy.

The user interface unit is mounted on a terminal and provides an interface for a user to acquire information. The terminal is provided with a touch screen or a voice recognition device for the user to input a search word. When the user inputs a specific search word, that information is transmitted from the terminal to the server via encrypted communication. The server extracts related data based on the received search word and transmits the analysis result to the terminal. The terminal visually provides the received information to the user. For example, it indicates the occurrence location of a forest fire on a map and displays the damage range in different colors. It displays the path of a typhoon as an animation and indicates the predicted affected area. Also, as a text-format report, it is also possible to explain the analysis result in detail and visualize it using graphs and charts so that the user can easily understand it. Furthermore, the user can save the information or share it with other users. This allows the user to quickly and accurately grasp phenomena occurring on the earth.

The user interface unit (information provision unit) may be configured by, for example, the computer 22 (the processor 28 and the like) and the communication I/F of the data processing apparatus 12, or may be configured by the specific processing unit 290, the specific processing program 56, and the like.

### Implementation Steps

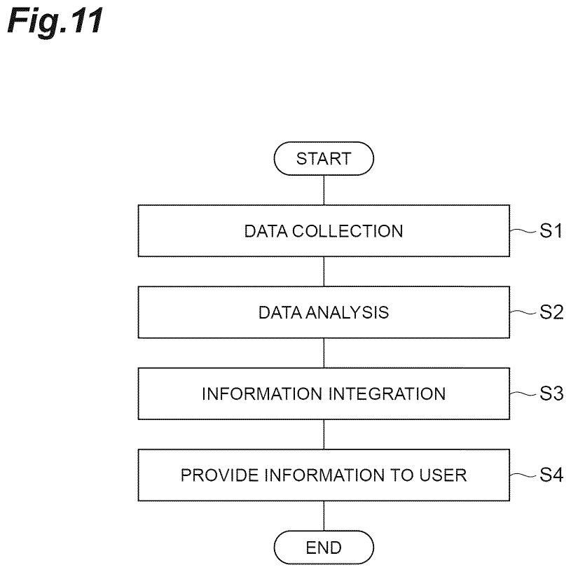

### Step 1: Data Collection (Refer to Step S1 of FIG. 11)

Collection of earth observation data is performed on the server side. The server is equipped with an advanced communication module for receiving data from a plurality of satellites orbiting the earth. This communication module receives high-resolution data acquired using optical sensors or synthetic aperture radar. For example, weather data such as cloud movement, temperature, humidity, and precipitation are acquired in real time from weather satellites. From environmental satellites, the health status of forests, vegetation indices, changes in ocean color, glacier movements, and the like are observed. These data are accumulated in a large-capacity database within the server and managed in time series.

### Step 2: Data Analysis (Refer to Step S2 of FIG. 11)

Data analysis by generative AI is executed on the server side. The server is equipped with high-performance processors such as GPUs and TPUs, and analyzes enormous amounts of data at high speed using deep learning technology. For example, it analyzes satellite image data using a convolutional neural network and analyzes time-series data using a recurrent neural network or a long short-term memory network. This makes it possible, for example, to detect the occurrence location and scale of forest fires with high accuracy, or to predict the path of a typhoon from several hours to several days ahead. Also, by analyzing changes in ocean temperature, it is also possible to detect signs of El Niño and La Niña phenomena at an early stage. Specific examples of prompt sentences to be read into the generative AI include “Analyze the latest satellite images and identify the location of the forest fire” and “Predict the path of the typhoon based on the weather data of the past 24 hours”.

### Step 3: Information Integration (Refer to Step S3 of FIG. 11)

The information integration unit further integrates the data analyzed by the generative AI unit and generates comprehensive and multifaceted information by associating different types of data. For example, it evaluates the risk of flooding by combining weather data and topographical data, and constructs a damage prediction model. Also, by integrating ocean data and weather data, it is possible to monitor changes in marine ecosystems and use it for the management of fishery resources. Data mining technology and big data analysis technology are used for this integration process, and the accuracy and reliability of the information are improved.

### Step 4: Providing Information to a User (Refer to Step S4 of FIG. 11)

The user interface unit is mounted on a terminal and provides an interface for a user to acquire information. The terminal is provided with a touch screen or a voice recognition device for the user to input a search word. When the user inputs a specific search word, that information is transmitted from the terminal to the server via encrypted communication. The server extracts related data based on the received search word and transmits the analysis result to the terminal. The terminal visually provides the received information to the user. For example, it indicates the occurrence location of a forest fire on a map and displays the damage range in different colors. It displays the path of a typhoon as an animation and indicates the predicted affected area. Also, as a text-format report, it is also possible to explain the analysis result in detail and visualize it using graphs and charts so that the user can easily understand it. Furthermore, the user can save the information or share it with other users. This allows the user to quickly and accurately grasp phenomena occurring on the earth.

### Specific Use Case

For example, assume a situation where the possibility of a forest fire occurring in a certain area is increasing. This area is susceptible to the effects of a dry climate and strong winds, and large-scale fires have occurred in the past. It is important to monitor the weather conditions and vegetation status of this area in real time using earth observation data.

The data collection unit receives data from weather satellites and acquires weather information such as temperature, humidity, wind speed, and precipitation. Also, it acquires data indicating the health status of vegetation and the dryness of the soil from environmental satellites. These data are accumulated in a database within the server and managed in time series.

The generative AI unit analyzes these data and evaluates the risk of fire occurrence. It detects changes in vegetation from satellite images using a convolutional neural network, and performs time-series analysis of weather data using a recurrent neural network. This makes it possible to identify the location and time when a fire is predicted to occur. Specific examples of prompt sentences to be read into the generative AI include “Analyze the latest weather data and vegetation data and evaluate the fire occurrence risk” and “Predict the probability of fire occurrence under the current weather conditions based on past fire data”.

The information integration unit integrates the analysis results and generates a fire risk map. This map combines weather data and vegetation data to indicate areas where fire occurrence is predicted in different colors. Furthermore, it improves the accuracy of risk assessment by referring to past fire data and analyzing fire occurrence patterns under similar weather conditions.

The user interface unit provides a fire risk map to the user through a terminal. The user can select a specific area using the touch screen of the terminal and acquire detailed fire risk information for that area. For example, it indicates the location where a fire is predicted to occur on a map and displays high-risk areas in red. Also, it displays the predicted scale and affected area of the fire as an animation to support the user in promptly taking countermeasures.

In this way, the system may evaluate the risk of forest fire occurrence in real time using earth observation data and provide quick and accurate information to the user. This can contribute to early warning of disasters and reduction of damage.

### EXAMPLE 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

This system is an environmental monitoring system for an entire city and is composed of a data collection unit, a generative AI unit, an information integration unit, and a user interface unit.

The data collection unit acquires data from a wide variety of sensors, cameras, drones, and the like installed within the city. For example, cameras on roads for monitoring traffic volume are installed, and these cameras are arranged at major intersections and key traffic points to monitor vehicle flow and congestion status in real time. This provides data for preventing the occurrence of traffic congestion. Furthermore, air sensors are installed in various parts of the city and measure the concentration of air pollutants such as PM2.5, nitrogen dioxide, and ozone. This provides information for early detection of air quality deterioration and for protecting the health of residents. Acoustic sensors measure noise levels and provide data for solving noise problems, especially at night. These sensors transmit data to a server via wireless communication and are updated in real time.

In city monitoring, the data collection unit (an edge device such as a camera) includes a privacy protection module that applies a lightweight object detection model (for example, YOLO-Nano, etc.) to acquired image data before transmitting the data to a server, identifies a face of a person or a license plate region of a vehicle, and performs masking processing (anonymization processing). Furthermore, the edge device executes an event-driven type transmission protocol in which only numerical data such as traffic volume is transmitted during normal times, and high-resolution video data is transmitted only when the generative AI unit detects a sign of an “accident” or “congestion.”

Thereby, compared to a case where video is constantly streamed, a network load is reduced by 90% or more, and a risk of privacy infringement is reduced at a hardware level. This processing is realized by high-speed image recognition and communication control on the order of milliseconds, which cannot be performed by human mental processes.

The generative AI unit analyzes the data accumulated in the server. The server is equipped with high-performance processors such as GPUs and TPUs, and analyzes enormous amounts of data at high speed using deep learning technology. For example, it analyzes image data from cameras using a convolutional neural network and predicts the occurrence of traffic congestion. For example, it can analyze the flow of vehicles at a specific intersection and predict the possibility of congestion occurring within the next hour. It analyzes time-series data using a recurrent neural network and predicts peak times of energy consumption. This makes it possible to shift the peak of power demand and improve energy efficiency. Furthermore, it can analyze air quality data and issue warnings of environmental pollution. For example, if the concentration of PM2.5 rises sharply, it can issue a warning to residents to refrain from going out. Specific examples of prompt sentences to be read into the generative AI include “Analyze the latest traffic camera data and make a congestion prediction for the next hour” and “Predict tomorrow's peak time based on the energy consumption data of the past week”.

The information integration unit integrates the analyzed data and generates a dashboard for comprehensively grasping the situation of the entire city. This dashboard functions as a tool for city administrators to make quick decisions. For example, it displays areas where traffic congestion is predicted on a map and proposes alternative routes. Also, it can predict the time period when energy consumption will peak and take power-saving measures. Furthermore, it can identify areas where air quality is deteriorating and issue health warnings to residents. It is also possible to identify areas with high noise levels and provide data for taking noise countermeasures. This enables efficient management of the entire city and can improve the quality of life for residents.

The user interface unit provides an application that residents can access. Residents can acquire real-time city information through smartphones or tablets and use it in their daily lives. For example, through the application, it proposes routes to avoid areas with poor air quality or provides information on public transportation delays. Also, it is possible to notify of peak energy consumption times and encourage power saving. It can propose routes to avoid areas with high noise levels and improve the quality of life for residents. Furthermore, residents can provide feedback on the city's environmental situation through the application, which can improve the accuracy and reliability of the system.

In this way, the system may achieve efficient management of the entire city and improve the quality of life for residents. This is expected to contribute to the realization of a sustainable city.

### System Configuration

The system includes a data collection unit, a generative AI unit, an information integration unit, and a user interface unit. The data collection unit acquires data from a wide variety of sensors, cameras, drones, and the like installed within the city. For example, cameras on roads for monitoring traffic volume are installed, and these cameras are arranged at major intersections and key traffic points to monitor vehicle flow and congestion status in real time. This provides data for preventing the occurrence of traffic congestion. Furthermore, air sensors are installed in various parts of the city and measure the concentration of air pollutants such as PM2.5, nitrogen dioxide, and ozone. This provides information for early detection of air quality deterioration and for protecting the health of residents. Acoustic sensors measure noise levels and provide data for solving noise problems, especially at night. These sensors transmit data to a server via wireless communication and are updated in real time.

The generative AI unit analyzes the data accumulated in the server. The server is equipped with high-performance processors such as GPUs and TPUs, and analyzes enormous amounts of data at high speed using deep learning technology. For example, it analyzes image data from cameras using a convolutional neural network and predicts the occurrence of traffic congestion. For example, it can analyze the flow of vehicles at a specific intersection and predict the possibility of congestion occurring within the next hour. It analyzes time-series data using a recurrent neural network and predicts peak times of energy consumption. This makes it possible to shift the peak of power demand and improve energy efficiency. Furthermore, it can analyze air quality data and issue warnings of environmental pollution. For example, if the concentration of PM2.5 rises sharply, it can issue a warning to residents to refrain from going out. Specific examples of prompt sentences to be read into the generative AI include “Analyze the latest traffic camera data and make a congestion prediction for the next hour” and “Predict tomorrow's peak time based on the energy consumption data of the past week”.

The information integration unit integrates the analyzed data and generates a dashboard for comprehensively grasping the situation of the entire city. This dashboard functions as a tool for city administrators to make quick decisions. For example, it displays areas where traffic congestion is predicted on a map and proposes alternative routes. Also, it can predict the time period when energy consumption will peak and take power-saving measures. Furthermore, it can identify areas where air quality is deteriorating and issue health warnings to residents. It is also possible to identify areas with high noise levels and provide data for taking noise countermeasures. This enables efficient management of the entire city and can improve the quality of life for residents.

The user interface unit provides an application that residents can access. Residents can acquire real-time city information through smartphones or tablets and use it in their daily lives. For example, through the application, it proposes routes to avoid areas with poor air quality or provides information on public transportation delays. Also, it is possible to notify of peak energy consumption times and encourage power saving. It can propose routes to avoid areas with high noise levels and improve the quality of life for residents. Furthermore, residents can provide feedback on the city's environmental situation through the application, which can improve the accuracy and reliability of the system.

In this way, the system may achieve efficient management of the entire city and improve the quality of life for residents. This is expected to contribute to the realization of a sustainable city.

### Implementation Steps

### Step 1: Data Collection

In the data collection step, data is acquired from a wide variety of sensors, cameras, drones, and the like installed within the city. For example, cameras on roads for monitoring traffic volume are installed, and these cameras are arranged at major intersections and key traffic points to monitor vehicle flow and congestion status in real time. This provides data for preventing the occurrence of traffic congestion. Furthermore, air sensors are installed in various parts of the city and measure the concentration of air pollutants such as PM2.5, nitrogen dioxide, and ozone. This provides information for early detection of air quality deterioration and for protecting the health of residents. Acoustic sensors measure noise levels and provide data for solving noise problems, especially at night. These sensors transmit data to a server via wireless communication and are updated in real time.

### Step 2: Data Analysis

In the data analysis step, generative AI analyzes the data accumulated in the server. The server is equipped with high-performance processors such as GPUs and TPUs, and analyzes enormous amounts of data at high speed using deep learning technology. For example, it analyzes image data from cameras using a convolutional neural network and predicts the occurrence of traffic congestion. For example, it can analyze the flow of vehicles at a specific intersection and predict the possibility of congestion occurring within the next hour. It analyzes time-series data using a recurrent neural network and predicts peak times of energy consumption. This makes it possible to shift the peak of power demand and improve energy efficiency. Furthermore, it can analyze air quality data and issue warnings of environmental pollution. Specific examples of prompt sentences to be read into the generative AI include “Analyze the latest traffic camera data and make a congestion prediction for the next hour” and “Predict tomorrow's peak time based on the energy consumption data of the past week”.

### Step 3: Information Integration

In the information integration step, the analyzed data is integrated to generate a dashboard for comprehensively grasping the situation of the entire city. This dashboard functions as a tool for city administrators to make quick decisions. For example, it displays areas where traffic congestion is predicted on a map and proposes alternative routes. Also, it can predict the time period when energy consumption will peak and take power-saving measures. Furthermore, it can identify areas where air quality is deteriorating and issue health warnings to residents. It is also possible to identify areas with high noise levels and provide data for taking noise countermeasures. This enables efficient management of the entire city and can improve the quality of life for residents.

### Step 4: User Interface

In the user interface step, an application that residents can access is provided. Residents can acquire real-time city information through smartphones or tablets and use it in their daily lives. For example, through the application, it proposes routes to avoid areas with poor air quality or provides information on public transportation delays. Also, it is possible to notify of peak energy consumption times and encourage power saving. It can propose routes to avoid areas with high noise levels and improve the quality of life for residents. Furthermore, residents can provide feedback on the city's environmental situation through the application, which can improve the accuracy and reliability of the system.

### Specific Use Case

For example, assume a situation where the problems of traffic congestion and air pollution are becoming serious in a certain city. This city has a high concentration of major business districts and residential areas, and traffic volume increases sharply during commuting hours. As a result, congestion frequently occurs on major roads, and exhaust gas emitted from vehicles exacerbates air pollution.

The data collection unit acquires traffic volume data in real time from cameras installed at major intersections and arterial roads in the city. In addition to this, air sensors measure the concentration of PM2.5 and nitrogen dioxide and collect air quality data. These data are transmitted to a server via wireless communication and accumulated in a database.

The generative AI unit analyzes the accumulated traffic volume data and predicts the occurrence of traffic congestion. It analyzes image data from cameras using a convolutional neural network and grasps the flow of vehicles. It analyzes time-series data using a recurrent neural network and predicts the possibility of congestion occurring within the next hour. Furthermore, it can analyze air quality data and issue warnings of environmental pollution. Specific examples of prompt sentences to be read into the generative AI include “Analyze the latest traffic camera data and make a congestion prediction for the next hour” and “Issue an environmental pollution warning based on the current air quality data”.

The information integration unit integrates the analysis results and generates a dashboard for comprehensively grasping the situation of the entire city. This dashboard functions as a tool for city administrators to make quick decisions. For example, it displays areas where traffic congestion is predicted on a map and proposes alternative routes. Also, it can identify areas where air quality is deteriorating and issue health warnings to residents.

The user interface unit provides an application that residents can access. Residents can acquire real-time city information through smartphones or tablets and use it in their daily lives. For example, through the application, it proposes routes to avoid areas with poor air quality or provides information on public transportation delays. Furthermore, residents can provide feedback on the city's environmental situation through the application, which can improve the accuracy and reliability of the system.

In this way, the system may achieve efficient management of the entire city and improve the quality of life for residents. This is expected to contribute to the realization of a sustainable city.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The specific processing unit 290 causes an “emotion state” on a system side in the emotion identification model 59 to transition based on a disaster risk level output from the generative AI unit (analysis of earth observation data). For example, when disaster information with high urgency (tsunami, large-scale forest fire) is detected, the emotion state of the system (robot or smart device) is transitioned to a “tension” or “warning” mode, and an output to the user (tone of voice, color of LED, priority of information to be presented) is changed.

During normal times, a detailed weather explanation is generated based on an emotion value of “relief,” but during an emergency, a prompt (System Prompt) to the data generation model 58 is dynamically rewritten so as to generate only a conclusion (evacuation instruction) in a short sentence together with a high-frequency warning sound based on an emotion value of “impatience.” This makes it possible to intuitively transmit information on which the user should act immediately from among a vast amount of observation data without imposing a cognitive load.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

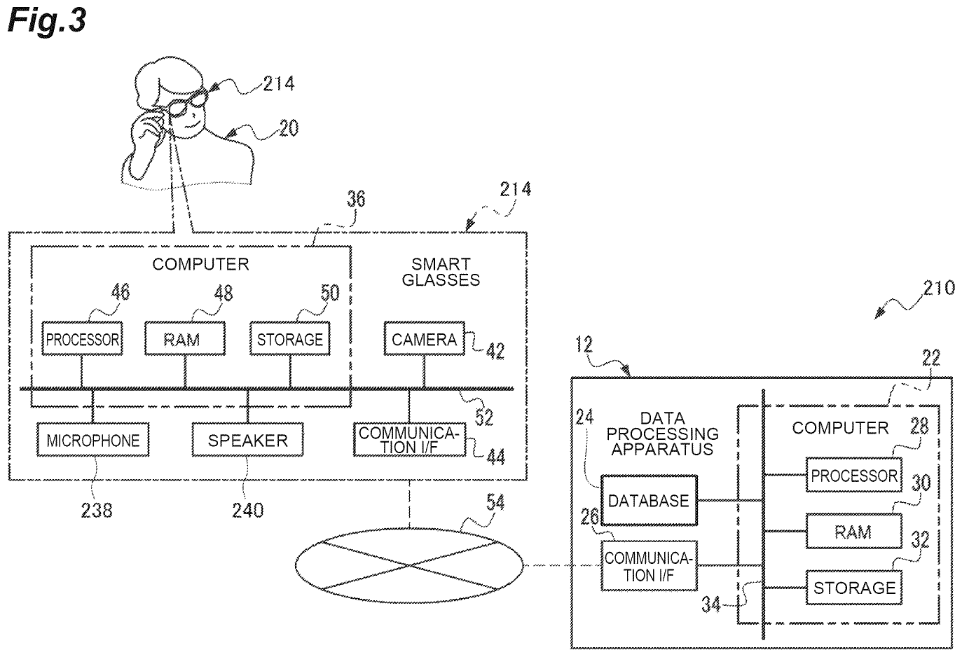

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

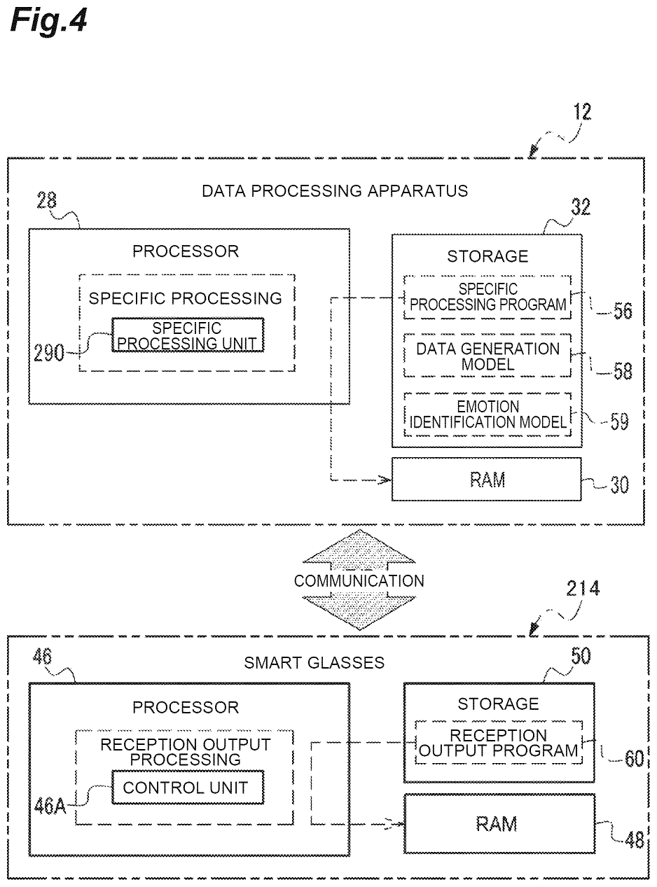

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 may have a data generation model and an emotion identification model similar to the data generation model 58 and the emotion identification model 59, and can also perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### EXAMPLE 2.1

Since the flow of the specific processing is the same as that in Example 1.1 described in the first embodiment, a description thereof is omitted.

### EXAMPLE 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

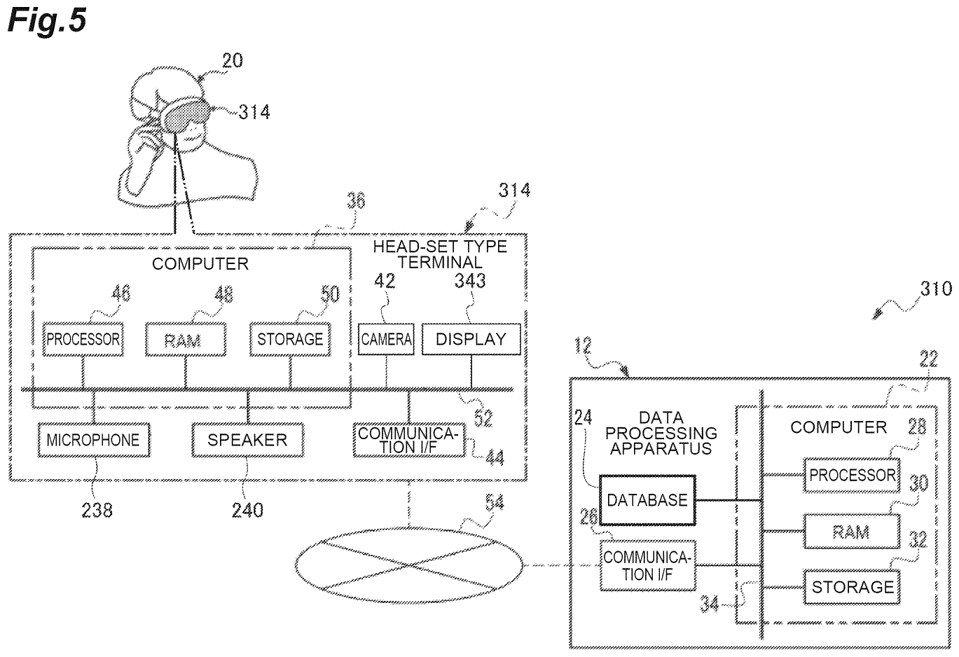

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

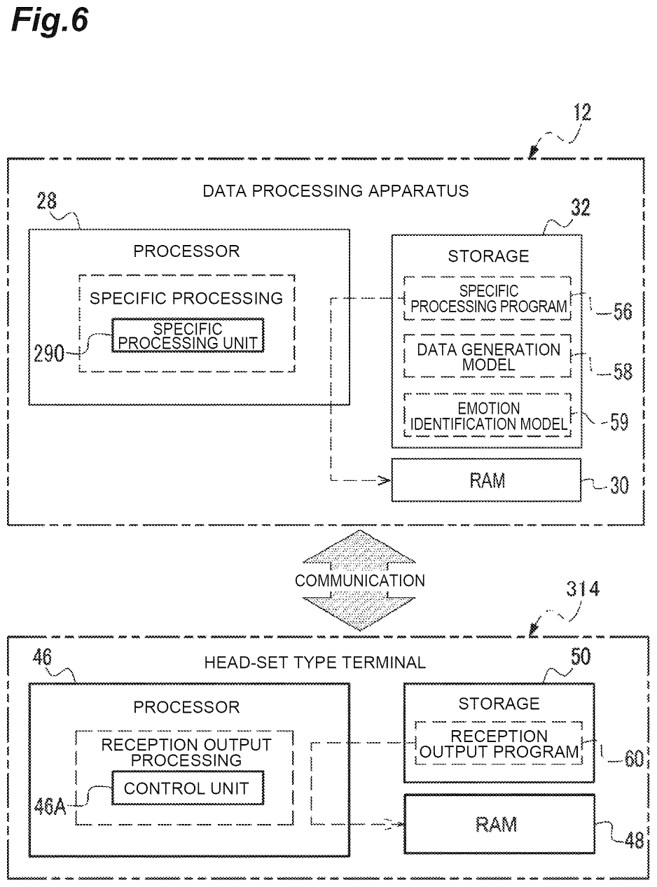

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### EXAMPLE 3.1

Since the flow of the specific processing is the same as that in Example 1.1 described in the first embodiment, a description thereof is omitted.

### EXAMPLE 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

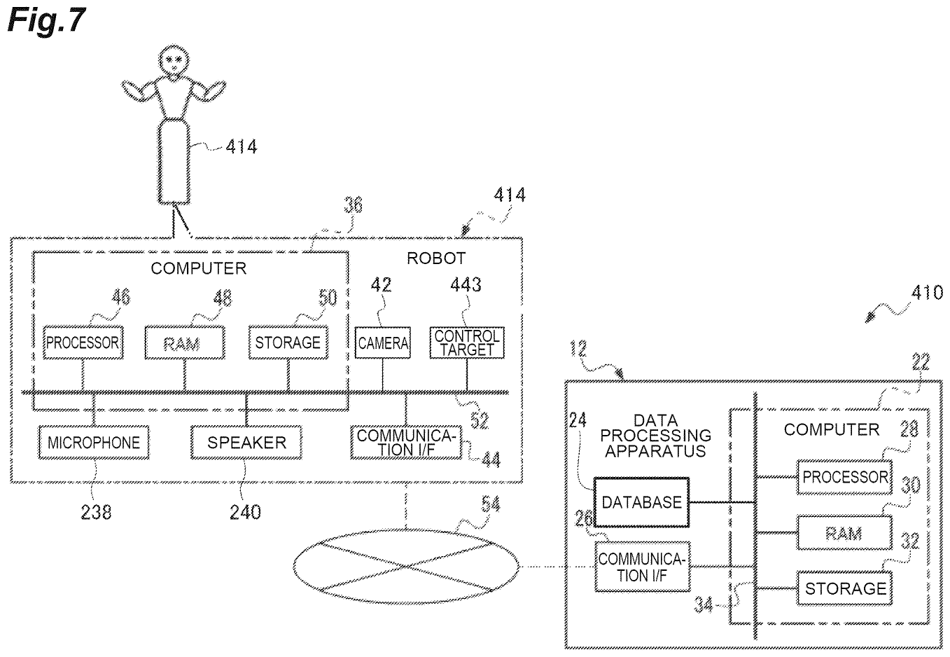

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

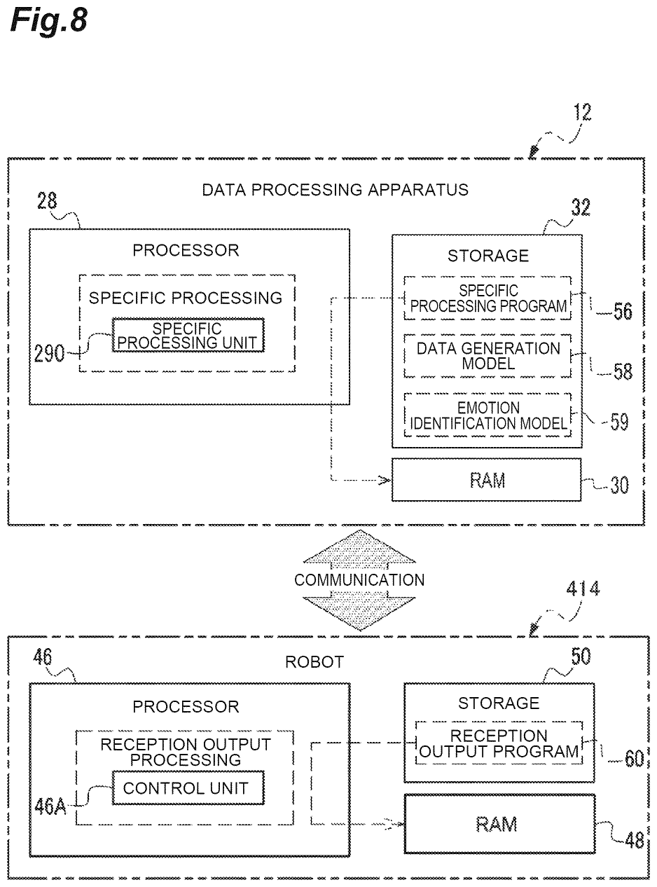

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### EXAMPLE 4.1

Since the flow of the specific processing is the same as that in Example 1.1 described in the first embodiment, a description thereof is omitted.

### EXAMPLE 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

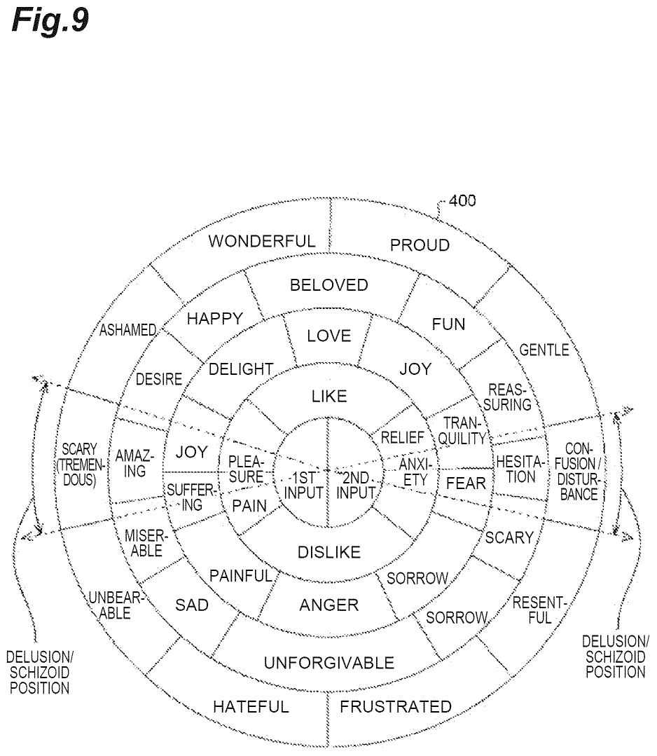

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.ni.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

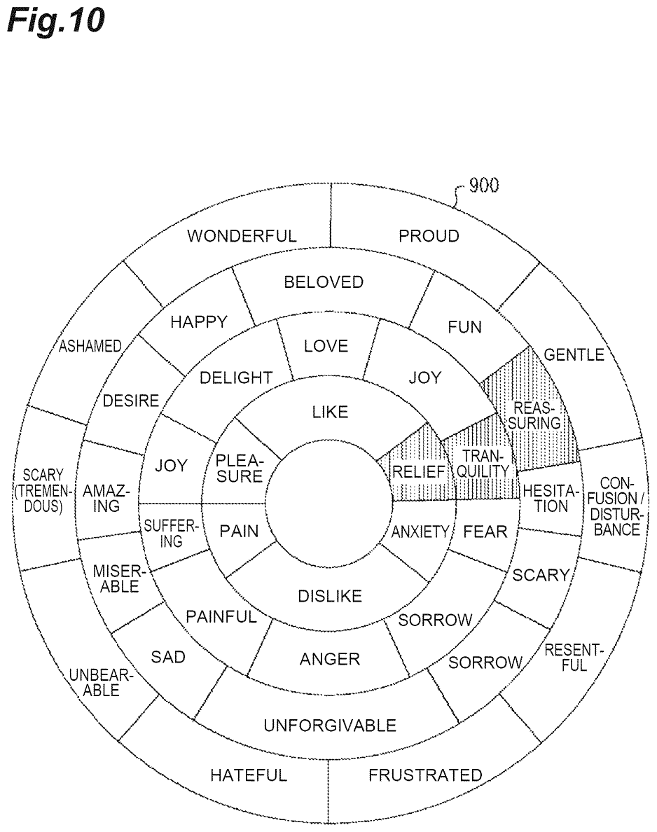

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a SaaS (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system comprising a data collection unit, a generative AI unit, an information integration unit, and a user interface unit. The data collection unit acquires data such as traffic volume, air quality, noise level, and energy consumption in real time from sensors, cameras, and drones installed in a city, and transmits the data to a server. The generative AI unit analyzes the acquired data and performs prediction of traffic congestion, optimization of energy consumption, and warning of environmental pollution. The information integration unit integrates the analysis results and generates a dashboard for comprehensively grasping the situation of the entire city. The user interface unit provides an application that residents can access and visually displays real-time city information.

In some examples, the data collection unit monitors traffic volume using cameras on roads and grasps the flow of vehicles at major intersections in real time. The generative AI unit analyzes image data using a convolutional neural network and predicts the occurrence of traffic congestion. The information integration unit displays areas where traffic congestion is predicted on a map and proposes alternative routes.

In some examples, the data collection unit measures air quality using air sensors and acquires PM2.5 and carbon dioxide concentrations in real time. The generative AI unit analyzes the air quality data and issues warnings of environmental pollution. The information integration unit identifies areas where air quality is deteriorating and issues health warnings to residents. The user interface unit proposes routes to residents for avoiding areas with poor air quality.

An example system for monitoring a global environment may include circuitry. The circuitry may be configured to: acquire earth observation data; acquire analysis data by analyzing the acquired earth observation data; and integrate the analyzed data and provide the integrated data to a user.

In some examples, acquiring the earth observation data may include acquiring the earth observation data including weather information, a change in topography, vegetation status, and a movement of an ocean with high resolution from at least one satellite orbiting the earth.

In some examples, acquiring the analysis data may include: preprocessing the acquired earth observation data; analyzing image data and time-series data using a convolutional neural network and a recurrent neural network; and detecting an occurrence location and a scale of a forest fire, a path prediction of a typhoon, and a temperature change of an ocean.

An example method of monitoring a global environment may include: acquiring earth observation data; acquiring analysis data by analyzing the acquired earth observation data; and integrating the analyzed data and providing the integrated data to a user.

What is claimed is:

1. A system for monitoring a global environment, the system comprising circuitry,
wherein the circuitry is configured to:
acquire earth observation data;
acquire analysis data by analyzing the acquired earth observation data; and
integrate the analyzed data and provide the integrated data to a user.

2. The system according to claim 1, wherein acquiring the earth observation data includes acquiring the earth observation data including weather information, a change in topography, vegetation status, and a movement of an ocean with high resolution from at least one satellite orbiting the earth.

3. The system according to claim 1, wherein acquiring the analysis data includes:
preprocessing the acquired earth observation data;
analyzing image data and time-series data using a convolutional neural network and a recurrent neural network; and
detecting an occurrence location and a scale of a forest fire, a path prediction of a typhoon, and a temperature change of an ocean.

4. A method of monitoring a global environment, the method comprising:
acquiring earth observation data;
acquiring analysis data by analyzing the acquired earth observation data; and
integrating the analyzed data and providing the integrated data to a user.
